(19) United States
(12) Patent Application Publication
(10) Pub. No.: US 2013/0155713 A1
(43) Pub. Date: Jun. 20, 2013

(54) Flexible Light Bar With Epoxy

(71) Applicants: Calvin Chuen Kam Law, Diamond Bar, CA (US); George Lee, Brea, CA (US)

(72) Inventors: Calvin Chuen Kam Law, Diamond Bar, CA (US); George Lee, Brea, CA (US)

(21) Appl. No.: 13/331,911

(22) Filed: Dec. 20, 2011

(51) Int. Cl. F21S 8/10; B29C 65/48

(52) U.S. Cl. 362/545; 264/1.7

(57) ABSTRACT

A light bar apparatus is disclosed. The light bar apparatus is attached to a vehicle and comprises a plurality of LED lights capable of illuminating in patterns signaled by the vehicle. The light bar is made at least in part of thermosetting polymer material such that the curing of the thermosetting polymer results in a protective layer for the LED lights by shielding the LED lights from excessive vibration from a vehicle in motion.

### FIELD OF THE INVENTION

This present invention relates generally to a vehicular lighting device. Specifically, the present invention is related to a vehicular lighting device in an elongated bar affixed to the rear of the vehicle, where the epoxy is used within the bar to stabilize the lighting apparatus in the bar.

### BACKGROUND OF THE INVENTION

Over the last few years, Light Emitting Diodes (LEDs) light bars have seen an increase in demand as consumers seek novel ways to accessorize and customize their vehicles while also gaining added safety. LED-based lighting is becoming very popular for several reasons: light-emitting diodes are small, completely solid state, very power-efficient, and have very long lives having no filaments to burn out. These LED light bars work as running lights, brake lights, turn signals, and reverse lights, as well as for cosmetic purposes.

Typically, the light bar is installed to the rear or front of the vehicle and connected to a vehicle's standard 4-pin flat trailer light connector. The light bar can reproduce the appropriate light sequence that built-in lights on rear of the vehicle would produce for a given situation: (1) by functioning as running lights by default; (2) the entire light bar is illuminated when braking; (3) the left half of the light bar flashes when a left turn is signaled; and (5) when the vehicle is shifted into reverse and the light bar turns on the LEDs. These LEDs create a “safety zone” behind the vehicle for safe, confident maneuvering.

Consumers can also attach the light bar between the tailgate and bumper as a stylish aftermarket makeover for their truck. Auto enthusiasts often seek new ways to distinguish their vehicle from the stock model by accessorizing the exterior of their vehicle with aftermarket parts including but not limited to light bulbs, light covers, rims, and body kits.

Light bars are typically made of LEDs enclosed in a solid and rigid, plastic material. A limiting factor to the economic viability of light bars, however, has been their associated shipping costs because of its rigid, lengthy structure. Alternatively, light bars can also be made of flexible, rubber-like material that can be rolled up for easy shipping and storage. In both types of light bars, the enclosed LED lights can be damages during shipping from improper packaging or even storage.

Furthermore, after the light bars are mounted on the vehicle, the LED lights may also be damaged over time. As the vehicle is being driven, the vehicle causes vibration which extends to the light bar, and therefore, extends to the LED lights. Over time, the vibration causes damage to the LED lights enclosed in the light bar, thus causing the need to repair LED lights or to replace the light bar altogether.

The present invention provides for a light bar, wherein the light bar enclosing the LED lights is filled with liquid or malleable, thermosetting polymer such as epoxy, thereby stabilizing and protecting the LED lights of the light bar.

### OBJECTIVE OF THE INVENTION

Accordingly, it is an object of this invention to create an apparatus enclosure with LED lights and filled with liquid or malleable, thermosetting polymer, wherein the said apparatus can be mounted on a vehicle.

It is an object of the invention to inject liquid or malleable, thermosetting polymer to the light bar for protecting the LED lights, wherein the polymerization of the thermosetting polymer as a result of curing forms a tough or hardened layer around the LED lights.

It is an object of the invention to provide a light bar for mounting on a vehicle, wherein the lights may serve as running lights, brake lights, turn signals, and reverse lights, or may be use for cosmetic purposes.

It is also an object of the invention to use the thermosetting polymer after it has cured to protect the LED lights in the light bar, wherein the thermosetting polymer such as epoxy absorbs any vibration or shock from use with the vehicle, thereby prolonging the usable life of the LED lights and therefore the usable life of the said light bar.

### SUMMARY OF THE INVENTION

The present invention comprises an apparatus suitable for use as a light bar that is filled with liquid or malleable, thermosetting polymer, such as epoxy.

In one embodiment, the light bar apparatus comprises of a plurality red LED lights, whereby said red LED lights are capable of lighting up in specific patterns with respect to whether the vehicle is in motion, engaging its brakes, or indicating an imminent turn to the left or right. In one embodiment, a plurality of amber LED lights is evenly interspersed between different red LED lights, wherein the said amber LED lights are capable of lighting up in specific patterns, indicating an imminent turn of the vehicle to the left or to the right.

In one embodiment, a plurality of white LED lights is evenly interspersed between the red LED lights, wherein the said white LED lights are capable of lighting up to signal a vehicle engaged in reverse motion. In one embodiment, the light bar is preferably filled at least in part with liquid or malleable, thermosetting polymer such as epoxy to protect and stabilize the LED lights.

In one aspect of the invention, a lighting apparatus suitable for use as a vehicle light bar comprised of a partially transparent bar shaped enclosure, wherein the bar shaped enclosure encloses a plurality of LED lights, wherein a space between the bar shaped enclosure and the LED lights is filled with a polymer, wherein the polymer is capable of stabilizing the LED lights against vibration generated by a moving vehicle. In one embodiment, the LED lights are placed in a bar shaped substrate. In another embodiment, the space is entirely filled with the polymer. In one other embodiment, the polymer is an epoxy polymer.

In one embodiment, the LED lights are capable of lighting up in a specific pattern. In another embodiment, the LED lights are comprised of different color LED lights. In one embodiment, the LED lights are comprised of a plurality of amber LED lights evenly placed between a plurality of red LED lights. In yet another embodiment, the LED lights are comprised of a plurality of white LED lights evenly placed between a plurality of red LED lights.

In another aspect of the invention, a method to supplement an existing vehicle lighting is disclosed comprising provide a partially transparent bar shaped enclosure, provide a plurality of LED lights, have the enclosure to enclose the LED lights, filling a space between the enclosure and the LED lights with a polymer wherein the polymer is capable of stabilizing the LED lights against vibration generated by a moving vehicle.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is a drawing illustrating the primary components of LED light bar apparatus that operates in accordance with the present invention.

FIG. 2 is a drawing of the pre-assembled components of the LED light bar apparatus, wherein there is the light bar enclosure, the thermosetting polymer, and the LED lights.

FIG. 3 is a drawing of a close-up of the LED light bar, wherein the thermosetting polymer protective layer absorbs vibration to protect the LED lights

FIG. 4 is a drawing of the LED light bar fixed to the rear of the vehicle, wherein the adapter of the light bar is connected to the plus of the vehicle for power.

### DETAIL DESCRIPTION OF THE INVENTION

The present invention is a liquid or malleable, thermosetting polymer-filled light bar. In the following description, specific details are set forth in order to provide a more thorough description of the present invention. It will be apparent, however, to one skilled in the art, that the present invention may be practice without the specific details. In other instances, well-known features have not been described in detail so as not to obscure the invention.

The present invention comprises a lengthy structure suitable for placement at the rear of the vehicle wherein plurality of LED lights are strung together for signaling the vehicle's current state. The light bar enclosure is filled at least in part with liquid or malleable, thermosetting polymer such as epoxy. The thermosetting polymer allows the LED lights to be shielded from external shock or vehicular vibration during operation, resulting in prolonging the usable life of the LED lights and thus the light bar.

One embodiment of a light bar in accordance with the present invention is a light bar wherein the enclosure is filled at least in part with liquid or malleable, thermosetting polymer, such as epoxy. The LED lights are then fitted into the light bar, wherein the thermosetting polymer cures to form a protective, scratch-resistant, and shock-resistant layer for the LED lights.

In one embodiment, the light bar is of the type that is placed on or affixed to the rear or front bumper of a vehicle and includes red, white, and amber LED lights.

In one embodiment, the light bar generally attaches to the front or rear of the vehicle. The body of the light bar comprises a plurality of colored LED lights connected together along the length of the structure. An adapter connects to the vehicle's plug to receive power and/or signal input.

The light bar is affixed to either the front of the vehicle or the rear of the vehicle by adhesive pads to the vehicle. The light bar can also be affixed by other methods and materials such as magnets and glues. When correctly installed onto the vehicle, LED lights of the light bar face outward from the vehicle and the back of the light bar faces towards the vehicle.

In the same embodiment, the light bar contains red LED lights that illuminate in accordance to the signal input received from the vehicle by way of the adapter of the light bar connected to the plug of the vehicle. All the red LED lights illuminate to signal a vehicle engaged in braking The LED lights on the left half of the light bar body illuminate to signal a vehicle's intent to change direction to the left. The red LED lights on the right half of the light bar body illuminate to signal a vehicle's intent to change direction to the right.

In the same embodiment, the light bar contains white LED lights that illuminate in accordance to the signal input received from the vehicle by way of the adapter of the light bar connected to the plug of the vehicle. All of the white LED lights illuminate to signal a vehicle engaged in reverse motion.

In the same embodiment, the flexible light bar contains amber LED lights that illuminate in accordance to the signal input received from the vehicle by way of the trailer adapter of the light bar connected to the plug of the vehicle. The amber lights of the left half of the light bar body illuminate to signal a vehicle's intent to change direction to the left. The amber LED lights on the right half of the light bar body illuminate to signal a vehicle's intent to change direction to the right.

In one embodiment, the length of the light bar is adjustable by adding on additional segments or by removing segments so that the length of the light bar fits the length of the vehicle.

In one embodiment, the LED lights of the flexible light bar can be illuminated at a variable pulse rate as desired by the end user. In one embodiment, the colors of the LED lights are interchangeable as to allow for customization by the end user. In one embodiment, the LED lights of the light bar can be controlled by means independent from the vehicle.

### DETAIL DESCRIPTION OF THE DRAWINGS

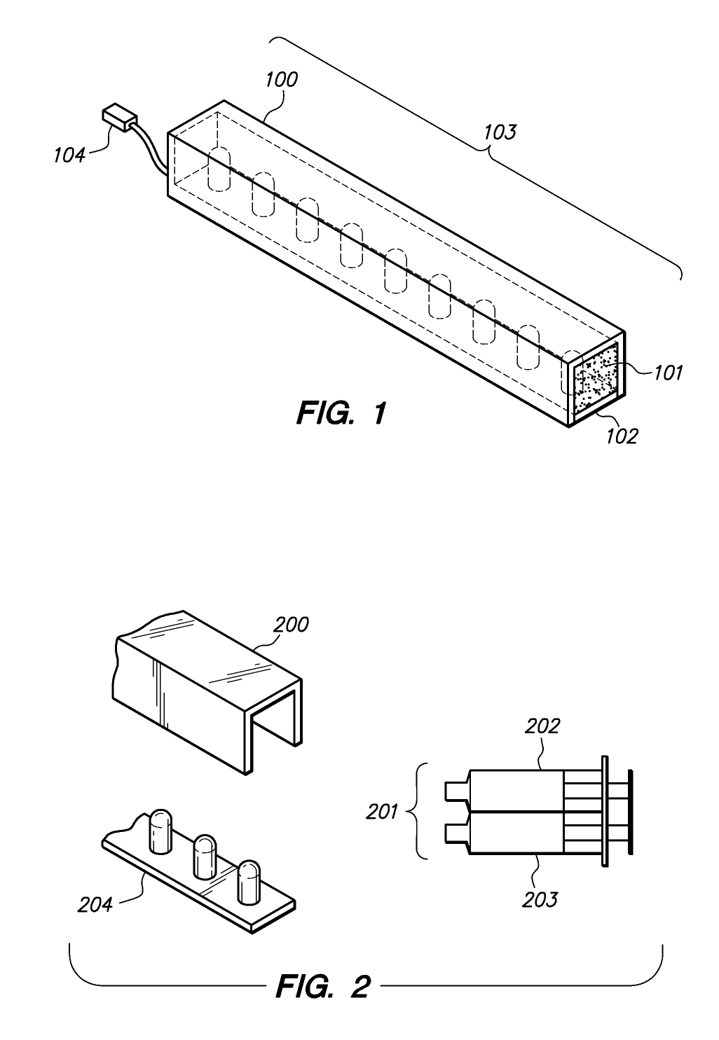

In FIG. 1, a drawing of the light bar apparatus is disclosed. The partially transparent light bar enclosure 100 contains thermosetting polymer 101 with LED lights 103 in the center, along the light bar 103. This allows the light emitted by the light bar to emit through the light bar enclosure. An adapter 104 extending out from the light bar body connects to a vehicle's plug to receive power and signal input.

In FIG. 2, a drawing of the light bar apparatus before assembly is disclosed. The light bar enclosure 200 is filled with liquid or malleable, thermosetting polymer 201, such as epoxy. In one embodiment, the thermosetting polymer 201, epoxy, is formed from reaction of an epoxide resin 202 with polyamine hardener 203, wherein the chemical reaction of the two results in epoxy, the curing of which is a hardened layer. The LED lights 204 are placed along the length of the light bar enclosure 200 as the thermosetting polymer cures, resulting in a LED light bar wherein the LED lights 204 are shielded by the thermosetting polymer 201.

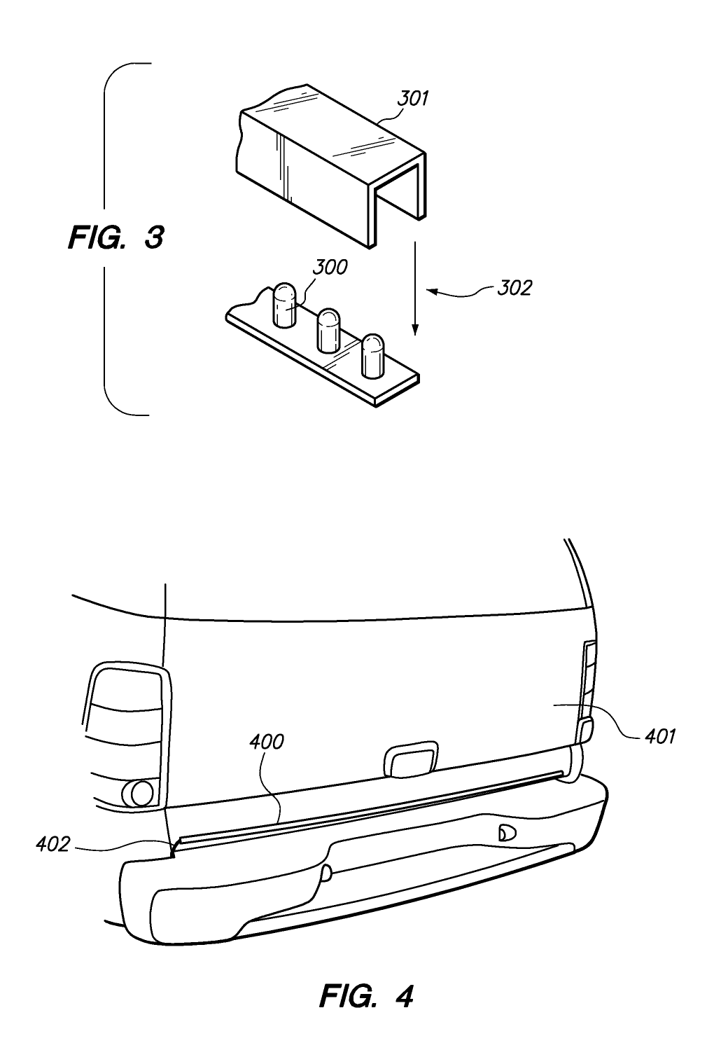

In FIG. 3, an up-close drawing of a segment of the light bar apparatus in its natural state is disclosed. The LED lights 300 are assembled together with the light bar enclosure 301 in which the thermosetting polymer 302 is enclosed. As attached to a vehicle being driven, the light bar is protected from damage from the vibration of the vehicle in motion. Specifically, the thermosetting polymer 302 in the light bar enclosure 301 absorbs excessive vibration of a vehicle in motion, resulting in minimal vibration to the LED lights 300.

In FIG. 4, a LED light bar 400 fixed to the rear of a vehicle 401 is disclosed. The light bar 400 is fixed to the rear of the vehicle 401, wherein the light bar adapter 402 is connected to the plus of the vehicle 401 for source of power for the individual LED lights.

1. A lighting apparatus suitable for use as a vehicle light bar comprised of a partially transparent bar shaped enclosure, wherein said bar shaped enclosure encloses a plurality of LED lights, wherein a space between said bar shaped enclosure and said LED lights is filled with a polymer, wherein said polymer is capable of stabilizing said LED lights against vibration generated by a moving vehicle.

2. The apparatus of claim 1 wherein said LED lights are placed in a bar shaped substrate.

3. The apparatus of claim 1 wherein said space is entirely filled with said polymer.

4. The apparatus claim of 1 wherein said polymer is an epoxy polymer.

5. The apparatus of claim 1 wherein said LED lights are capable of lighting up in a specific pattern.

6. The apparatus of claim 1 wherein said LED lights are comprised of different color LED lights.

7. The apparatus of claim 5 wherein said LED lights are comprised of a plurality of amber LED lights evenly placed between a plurality of red LED lights.

8. The apparatus of claim 5 wherein said LED lights are comprised of a plurality of white LED lights evenly placed between a plurality of red LED lights.

9. A method to supplement an existing vehicle lighting comprising:
a. provide a partially transparent bar shaped enclosure,
b. provide a plurality of LED lights,
c. have said enclosure to enclose said LED lights,
d. filling a space between said enclosure and said LED lights with a polymer wherein said polymer is capable of stabilizing said LED lights against vibration generated by a moving vehicle.

10. The method of claim 9 wherein said LED lights are placed in a bar shaped substrate.

11. The method of claim 9 wherein said space is entirely filled with said polymer.

12. The method claim of 9 wherein said polymer is an epoxy polymer.

13. The method of claim 9 wherein said LED lights are capable of lighting up in a specific pattern.

14. The method of claim 9 wherein said LED lights are comprised of different color LED lights.

15. The method of claim 14 wherein said LED lights are comprised of a plurality of amber LED lights evenly placed between a plurality of red LED lights.

16. The method of claim 14 wherein said LED lights are comprised of a plurality of white LED lights evenly placed between a plurality of red LED lights.
